(19) United States
(12) Patent Application Publication
(10) Pub. No.: US 2011/0310768 A1
(43) Pub. Date: Dec. 22, 2011

(54) METHOD AND APPARATUS FOR MODELING NETWORK TRAFFIC

(75) Inventor: Kwang Sik SHIN, Incheon (KR)

(73) Assignee: Electronics and Telecommunications Research Institute, Daejeon (KR)

(21) Appl. No.: 13/163,383

(22) Filed: Jun. 17, 2011

(30) Foreign Application Priority Data
Jun. 18, 2010 (KR) 10-2010-0058220

(51) Int. Cl. H04L 12/26

(52) U.S. Cl. 370/253

(57) ABSTRACT

A method for modeling network traffic includes: collecting traffic of data transmitted from a network; extracting a traffic density value based on any one of the data size, the packet size, and the IDT of the collected traffic and obtaining the probability density distribution on the raw domain; separating the data into the major dataset that is a group of data having the density value of the threshold value or more and the minor dataset that is a group of data having the data density value less than the threshold value; transforming the major dataset separated on the raw domain onto the major dataset domain formed to exclude a period corresponding to the data density value of a threshold value or less; and obtaining a major dataset analysis model by applying a graph fitting algorithm on the major dataset on the major dataset domain.

### CROSS-REFERENCE TO RELATED APPLICATIONS

This application claims priority under 35 U.S.C. §119 to Korean Patent Application No. 10-2010-0058220, filed on Jun. 18, 2010, in the Korean Intellectual Property Office, the disclosure of which is incorporated herein by reference in its entirety.

### TECHNICAL FIELD

The present invention relates to a method and apparatus for modeling a network traffic, and more particularly, to a method and apparatus for appropriately modeling network traffic reflecting large change.

### BACKGROUND

A technology for modeling network traffic according to the related art simply models traffic into burst and idle states according to a packet reaching period or an instantaneous change in a traffic amount from traffic flow analysis. Therefore, the technology for modeling network traffic according to the related art is difficult to model other traffic characteristics such as packet size distribution, and the like.

Meanwhile, the technology for modeling network traffic is important to appropriately separate the traffic distribution in order to model the traffic distribution in an analyzable manner.

The technology for modeling network traffic uses a method that separates a period of traffic distribution and models the traffic distribution with a random distribution function at each period in order to model the traffic distribution in response to considerable change such as an online game, and so on.

However, since the technology for modeling network traffic according to the related art divides traffic distribution with the random distribution function, traffic is separated by complicated distribution, that is, into too many data periods, such that it is difficult to actually use. Therefore, it is difficult for the technology for modeling network traffic to model the traffic distribution in an easily analyzable manner.

### SUMMARY

An exemplary embodiment of the present invention provides a method for modeling network traffic includes: collecting traffic of data transmitted from a network; extracting a traffic density value based on any one of the data size, the packet size, and the IDT of the collected traffic data and obtains the probability density distribution based on the raw domain; separating the data into major dataset that is a group of data having the density value of the threshold value or more and minor dataset that is a group of data having the data density value less than the threshold value; transforming the major dataset separated on the raw domain onto the major dataset domain formed to exclude a period corresponding to the data density value of a threshold value or less; and obtaining a major dataset analysis model by applying a graph fitting algorithm on the major dataset on the major dataset domain.

Another exemplary embodiment of the present invention provides an apparatus for modeling network traffic includes: a collector collecting traffic of data transmitted from a network; an extractor extracting the collected traffic density value based on any one of the data size, the packet size, and the IDT and obtaining the probability density distribution on the raw domain; a traffic modeling module separating the data into the major dataset that is a group of data having the density value of the threshold value or more and the minor dataset that is a group of data having the data density value less than the threshold value and obtaining a mathematical analysis model by modeling the major dataset.

Other features and aspects will be apparent from the following detailed description, the drawings, and the claims.

### BRIEF DESCRIPTION OF THE DRAWINGS

FIG. 1 is a flow chart showing a method for modeling network traffic according to an exemplary embodiment of the present invention;

FIG. 2 is an exemplified diagram showing a density value of a packet size with histogram, in predetermined traffic;

FIG. 3 is an exemplified diagram showing a density value of a packet size with a probability density function, in predetermined traffic;

FIG. 4 is an exemplified diagram showing a moving average value, in predetermined traffic;

FIG. 5 is an exemplified diagram showing a major dataset on a raw domain;

FIG. 6 is an exemplified diagram showing a major dataset on a major dataset domain;

FIG. 7 is a block diagram showing an apparatus for modeling network traffic according to an exemplary embodiment of the present invention; and

FIG. 8 is a block diagram showing a traffic modeling module in an apparatus for modeling network traffic according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

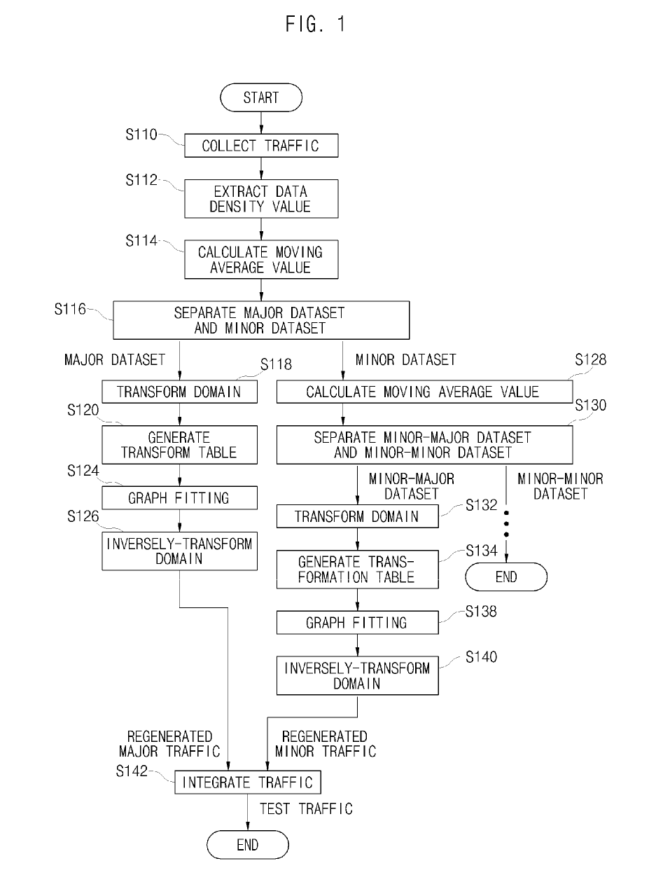

A method for modeling network traffic according to an exemplary embodiment of the present invention will be described with reference to FIG. 1. FIG. 1 is a flow chart showing a method for modeling network traffic according to an exemplary embodiment of the present invention.

As shown in FIG. 1, a method for modeling network traffic according to an exemplary embodiment of the present invention collects data traffic transmitted through a network (S110).

Thereafter, the method obtains density distribution of traffic from a raw domain based on any one of a data size, a packet size, and an inter-departure time (IDT) (S112).

That is, the raw domain is any one of the data size domain, the packet size domain, and the IDT domain and is selected according to traffic generating environment such as online game, broadcasting service, multimedia streaming service, wired/wireless communication, and so on, and the purpose of the network traffic modeling.

Therefore, the density of traffic will be any one of probability density of traffic amount per a data size, probability density of traffic amount per a packet size, and probability density of traffic amount per unit time according to the selected domain.

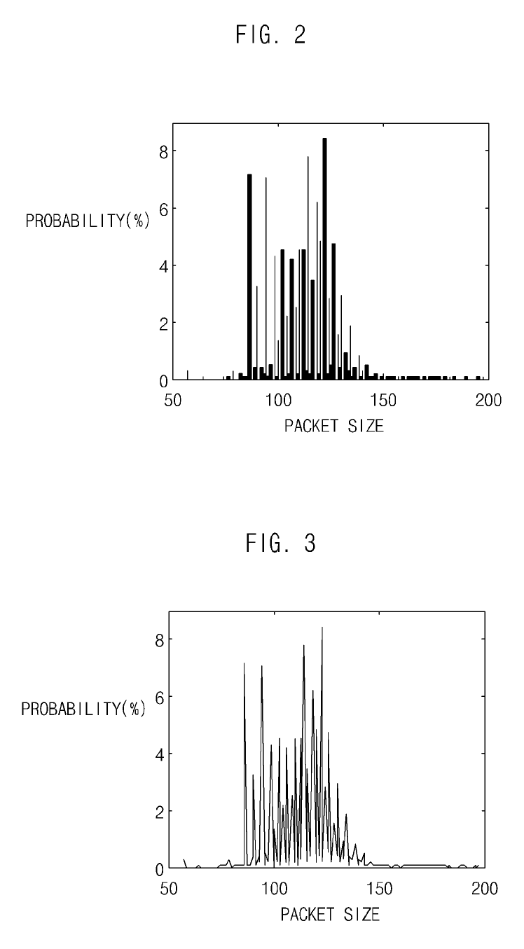

For example, as shown in FIGS. 2 and 3, a traffic density value corresponds to each period value (packet size from 0 to 200) on a raw domain based on a packet size in the collected network traffic.

Herein, FIG. 2 is an exemplified diagram showing a density value of a packet size with histogram, in predetermined traffic and FIG. 3 is an exemplified diagram showing a density value of a packet size with a probability density function, in predetermined traffic. Meanwhile, in FIGS. 2 and 3, an x-axis represents a packet size and a y-axis represents a density value.

In the above-mentioned description of step S112, the raw domain is not limited to the data size domain, the packet size domain, the IDT domain that are described above and therefore, other domains may be used as the raw domain.

Thereafter, the method calculates the moving average value that is a reference to separating data according to the traffic density value (S114).

Herein, the moving average value is a moving average value of the traffic density value corresponding to each period value on the raw domain.

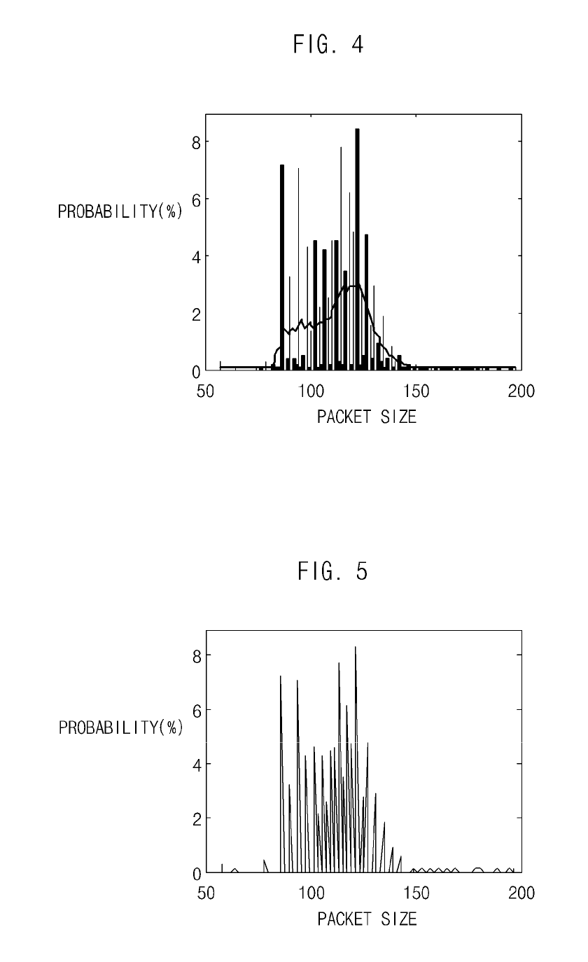

FIG. 4 shows the calculated moving average value of the traffic density value, in a packet size domain. An x-axis represents the packet size and a y-axis represents the traffic density value. Herein, a line passing through the average value of each density value represents the moving average of the traffic density value.

Thereafter, the method separates data into a major dataset that is a group of data having a density value of a threshold value or more and a minor dataset that is a group of data having a density value of a threshold value or less, based on a moving average value using a threshold value (S116).

Meanwhile, as the threshold value that is a reference of separating the major dataset, a predetermined constant other than the above-mentioned moving average value may be used or other values may be used. Then, a domain is transformed to include only the separated major dataset. In other words, the method transforms the raw domain onto the major dataset domain formed to exclude a period corresponding to the data density value of the threshold value or less (S118).

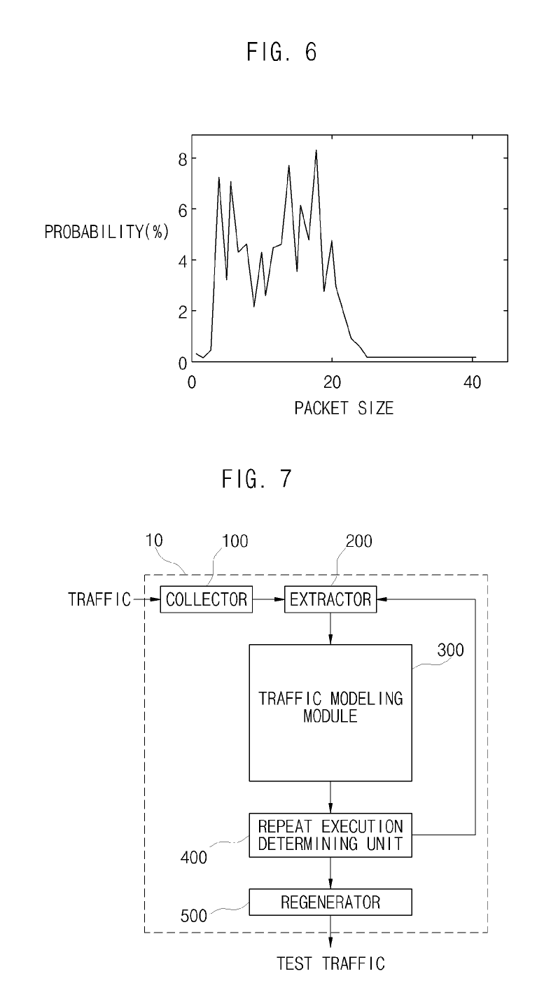

In other words, the traffic density distribution on the raw domain shown in FIG. 5 is transformed into the traffic density distribution on the major dataset domain shown in FIG. 6. In FIGS. 5 and 6, an x-axis represents the packet size and a y-axis represents the density value.

As shown in FIG. 5, the separated major dataset is formed of only the portion having the density value of the moving average value or more. That is, after the separation, since the minor dataset is removed on the raw domain, the discrete distribution is increased on the raw domain, such that it is difficult to model the major dataset.

In order to solve the above problem, as shown in FIG. 6, the major dataset domain is transformed onto the dataset domain to have the discrete distribution.

In this case, the method generates a major dataset transformation table indicating a relationship when the major dataset on the raw domain is transformed into a major dataset on the major dataset domain (S120).

Thereafter, the method searches a plurality of peaks showing a distribution graph and applies a graph fitting algorithm searching an appropriate mathematical model from the distribution graph to obtain the major dataset analysis model represented by a sum of the plurality of random distribution functions, for the major dataset on the major dataset domain (S124).

Herein, the graph fitting executes curve fitting to represent the distribution of the major dataset in a numerical formula. Meanwhile, the major dataset analysis model may be various types according to the purpose of traffic analysis, such as mathematical model, the probability density function model, the histogram model, or the like.

Thereafter, the method obtains the data distribution on the major dataset domain by using the analysis model obtained at step S124 and obtains regenerated major traffic by again referring to the major dataset transformation table obtained at step S120 to inversely transform the data distribution into the data distribution on the raw domain, when testing a network or a network load of a server by simulating the network traffic (S126).

Various tests such as a load test for a server or a network device for online game, or the like, may be executed by using the obtained regenerated major data.

The regenerated traffic generated by the above-mentioned method is obtained by the analysis model executing the modeling for some data of the real traffic, such that the similarity for the real traffic can be degraded. The same process is repeated for the above-mentioned minor dataset to solve the problem and the results are integrated, thereby making it possible to obtain regenerated traffic.

Hereinafter, a sequence of obtaining the regenerated minor traffic by modeling the minor dataset will be described.

A method for modeling the minor dataset is similar to a method for modeling the above-mentioned major dataset.

First, the method calculates the moving average value for the data density value of the minor dataset (S128).

Thereafter, the method separates the data of the minor dataset into a minor-major dataset having the density value of new threshold values (hereinafter, referred to as a minor threshold value for convenience of explanation) different from the above-mentioned threshold value and a minor-minor dataset having a data density value less than a minor threshold value (S130).

Thereafter, for transforming the domain, the raw domain is transformed into the minor dataset domain including only the minor-major dataset (S132).

In this case, the method generates the minor dataset transformation table representing the transformed relationship (S134).

Thereafter, the method obtains the minor-major dataset analysis model by using the graph fitting algorithm for the minor-major dataset on the minor dataset domain (S138).

As described above, two analysis models for each of the major dataset and the minor dataset are obtained by executing modeling twice and the regenerated data for testing are obtained by using the two analysis model, thereby making it possible to obtain the regenerated data that is closer to resembling the real data traffic.

The process of obtaining the regenerated data obtains the data distribution by using each analysis model and then, transforms the obtained data distribution into data on the raw domain by using each dataset transformation table to obtain the regenerated major dataset and the regenerated minor dataset (S126 and S140), thereby integrating the two dataset to obtain the regenerated traffic for testing (S142).

Meanwhile, the distribution of the regenerated major traffic, the regenerated minor traffic, and the regenerated traffic for testing may be represented by a sum of the plurality of random distribution functions according to the execution type of the above-mentioned graph fitting.

In order to resemble the regenerated traffic and the real traffic for this purpose, the process of modeling the regenerated data according to the above-mentioned method and integrating it into the test traffic may be repeated. As the modeling and integrating processes are repeated, the distribution of the test traffic resembles more to the distribution of the collected traffic.

For example, the dataset is separated based on the moving average value (low) different from the previously used moving average value and modeled according to the above-mentioned method. The results obtained through this process may be integrated into the test traffic. It is possible to further resemble the regenerated traffic for testing to the collected real traffic by repeatedly executing the integration.

The method for modeling network traffic according to an exemplary embodiment of the present invention extracts and models only some data while reflecting the characteristics of real traffic by appropriately applying the threshold value rather than executing the modeling on all the collected real traffic, thereby making it possible to easily and simply execute the traffic analysis. Further, the similarity to the real traffic can be continuously increased by repeating the process. In addition, the method for modeling network traffic according to an exemplary embodiment of the present invention can execute the analysis and modeling of the traffic based on the data size, the packet size, the IDT, etc., as well as the data distribution over time.

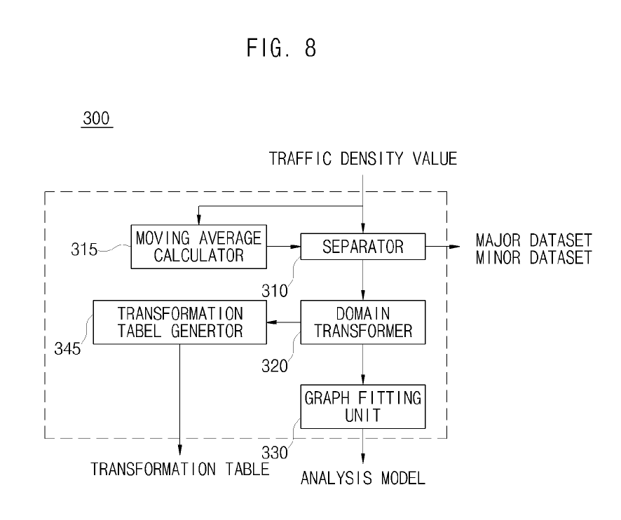

The apparatus for modeling network traffic according to an exemplary embodiment of the present invention will be described with reference to FIGS. 7 and 8. FIG. 7 is a block diagram showing an apparatus for modeling network traffic according to an exemplary embodiment of the present invention and FIG. 8 is a block diagram showing a traffic modeling module in an apparatus for modeling network traffic according to an exemplary embodiment of the present invention.

As shown in FIG. 7, the apparatus 10 for modeling network traffic according to an exemplary embodiment of the present invention includes a collector 100, an extractor 200, a traffic modeling module 300, a repeat execution determining unit 400, and a regenerator 500.

The collector 100 collects the data traffic transmitted through the network.

The extractor 200 extracts the traffic density value based on any one of the data size, the packet size, and the IDT of the collected data and obtains the probability density distribution based on the raw domain.

The traffic modeling module 300 separates the data into the major dataset that is a group of data having the density value of the threshold value or more and the minor dataset that is a group of data having the data density value less than the threshold value and models the major dataset to obtain a mathematical analysis model. Further, the transformation table indicating the relationship when the major dataset based on the raw domain is transformed into the major dataset on the major dataset domain is generated.

The repeat execution determining unit 400 receives the major dataset, the minor dataset, and the mathematical analysis model from the traffic modeling module 300 to analyze at least one of them, thereby determining whether or not to repeatedly execute the modeling. If it is determined that the repeat execution is needed, the minor dataset is provided to the extractor 200.

In order to determine whether the modeling is repeatedly executed, the repeat execution determining unit 400 compares the collected real traffic with the regenerated traffic to determine whether they are similar to each other. As a result, it can be determined whether the modeling is repeatedly executed. Herein, whether they are similar to each other can be determined by various methods, such as a method for using the concordance rate of the collected traffic with the regenerated traffic and the error of data, etc.

In addition, the repeat execution determining unit 400 may use the density value of the major dataset and the period of the major dataset domain, etc., in order to determine whether the modeling is repeatedly executed. For example, the repeat execution determining unit 400 can determine that the repeat execution is made when the difference between the largest density value of the major dataset and the smallest density value is a predetermined threshold value or more. In addition, the repeat execution determining unit 400 can determine that the repeat execution is made when the period of the major dataset domain is less than the predetermined threshold value.

Alternatively, the repeat execution determining unit 400 is based on the repeat execution but may be configured so that the repeat execution ends when the total sum of the data density of the remaining dataset after the separation is the predetermined value or less.

The regenerator 500 receives the mathematical analysis model and the transformation table from the traffic modeling module or the repeat execution determining unit 400 to obtain the data distribution using the mathematical analysis model and inversely transform the obtained data distribution using the transformation table, thereby generating the regenerated traffic for testing.

In addition, the regenerator 500 receives two or more (that is, repeat executed frequency) analysis models and the transformation table corresponding to each analysis model from the traffic modeling module or the repeat execution determining unit 400 when the repeat execution is made to obtain two or more regenerated traffics therefrom and integrate them, thereby obtaining the regenerated data for a test.

Alternatively, the regenerator 500 receives a new analysis model (for example, analysis model for minor dataset) according to the repeat execution of the modeling from the repeat execution determining unit 400 to integrate it with the regenerated traffic (for example, analysis model for major dataset) for the existing stored test, such that it may be configured of a method obtaining a new regenerated traffic for testing.

As the repeat execution of the modeling is continuously made by the apparatus 10 for modeling network traffic according to an exemplary embodiment of the present invention, the test traffic resembles closer to the real traffic. Meanwhile, it is preferable that the repeat execution frequency of the modeling is appropriately selected according to the purpose.

Meanwhile, as shown in FIG. 8, the traffic modeling module 300 may include a separator 310, a moving average calculator 315, a domain transformer 320, a graph fitting unit 330, a transformation table generator 345, in order to execute the modeling.

The separator 310 separates data into the major dataset that is a group of data having the density value of the threshold value (for example, moving average value) or more and the minor dataset that is a group of data having the data density value less than the threshold value.

The moving average calculator 315 calculates the moving average value that is a moving average value for the data density value.

The domain transformer 320 transforms the major dataset on the raw domain into the major dataset domain formed to exclude the minor dataset.

The graph fitting unit 330 applies the graph fitting algorithm that searches the plurality of peaks represented on the distribution graph for the major dataset on the major dataset domain and searches the mathematical model therefrom, thereby obtaining the analysis model represented by the sum of the plurality of random distribution function.

The transformation table generator 345 generates the transformation table indicating the relationship when the major dataset based on the raw domain is transformed into the major dataset on the major dataset domain.

As described above, the apparatus 10 for modeling network traffic according to an exemplary embodiment of the present invention extracts only some dataset while reflecting the characteristics of real traffic by appropriately applying the threshold value rather than performing the modeling on all the collected real traffics and models them, thereby making it possible to easily and simply execute the traffic analysis. Further, the similarity with the real traffic may be continuously increased by repeating the process. Further, the apparatus 10 for modeling network traffic according to an exemplary embodiment of the present invention can execute the analysis and modeling based on the data size, the packet size, the IDT, etc, as well as the data distribution over time.

In addition, the apparatus 10 for modeling network traffic according to an exemplary embodiment of the present invention appropriately models network traffic suffering considerable change such as online game, and so on and generating a test traffic of a pattern similar to real traffic therethrough.

According to the exemplary embodiments of the present invention, it models only the data that determine the characteristics of traffic by dividing the collected network traffic according to the data density value, thereby making it possible to easily model the network traffic in response to considerable change using simple calculations.

In addition, the present invention can execute modeling more approximately the real network traffic by repeating the separation and modeling according to the data density value.

The present invention can easily obtain the regenerated data well reflecting the characteristics of the real network traffic by using the modeling results.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for modeling network traffic, comprising:
collecting traffic of data transmitted from a network;
extracting a traffic density value based on any one of the data size, the packet size, and the IDT of the collected traffic and obtaining the probability density distribution on the raw domain;
separating the data into the major dataset that is a group of data having the density value of the threshold value or more and the minor dataset that is a group of data having the data density value less than the threshold value;
transforming the major dataset separated on the raw domain into the dataset on the major dataset domain formed to exclude the minor dataset period; and
obtaining a major dataset analysis model by applying a graph fitting algorithm on the transformed major dataset.

2. The method of claim 1, further comprising obtaining data density distribution on the major dataset domain by using the major dataset analysis model and inversely transforming the obtained data density distribution into the raw domain to obtain the regenerated major traffic.

3. The method of claim 2, wherein the threshold value is a moving average value for the probability density distribution.

4. The method of claim 1, wherein the transforming includes generating a major dataset transformation table indicating the relationship when the major dataset on the raw domain is transformed into the major dataset on the major dataset domain.

5. The method of claim 1, further comprising:
separating the data of the minor dataset into a minor-major dataset having a density value of a new threshold value or more different from the threshold value and a minor-minor dataset that is a group of data having the data density value less than the new threshold value;
transforming the minor-major dataset on the raw domain into the dataset on the minor dataset domain formed to exclude a period corresponding to the data density value of the new threshold value or less; and
obtaining a minor-major dataset analysis model by applying a graph fitting algorithm on the transformed minor dataset.

6. The method of claim 5, further comprising:
obtaining data density distribution on the minor dataset domain by using the minor-major dataset analysis model and inversely transforming the obtained data density distribution onto the raw domain to obtain the minor traffic; and
obtaining regenerated traffic for test by integrating the regenerated major traffic and the regenerated minor traffic.

7. The method of claim 5, further comprising repeatedly performing at least once steps of separating into the minor-minor dataset; transforming the dataset on the minor dataset domain; and obtaining the minor-major dataset analysis model.

8. The method of claim 5, further comprising generating a minor dataset transformation table indicating the relationship when the minor dataset on the raw domain is transformed into the minor dataset on the minor dataset domain.

9. The method of claim 1, wherein the density of the traffic is any one of probability density of traffic amount per a data size, probability density of traffic amount per a packet size, and probability density of traffic amount per a unit time according to the selected reference.

10. An apparatus for modeling network traffic, comprising:
a collector collecting traffic of data transmitted from a network;
an extractor extracting a collected traffic density value based on any one of the data size, the packet size, and the IDT and obtaining the probability density distribution on the raw domain;
a traffic modeling module separating the data into the major dataset that is a group of data having the density value of the threshold value or more and the minor dataset that is a group of data having the data density value less than the threshold value and obtaining a mathematical analysis model by modeling the major dataset.

11. The apparatus of claim 10, further comprising a repeat execution determining unit that receives the major dataset, the minor dataset, and the mathematical analysis model to analyze at least of them in order to determine whether the modeling is repeatedly executed and if it is determined that the repeat execution is needed, provides the minor dataset to the extractor.

12. The apparatus of claim 11, wherein the extractor receives the minor dataset from the repeat execution determining unit and extracts the traffic density value based on any one of the data size, the packet size, and the IDT of the minor dataset and obtains the probability density distribution based on the raw domain if it is determined that the repeat execution is needed.

13. The apparatus of claim 11, further comprising a regenerator generating regenerated traffic for test by receiving mathematical analysis model and the transformation table from the traffic modeling module or the repeat execution determining unit to obtain the data distribution using the mathematical analysis model and inversely transform the obtained data distribution using the transformation table to generate the regenerated traffic for a test.

14. The apparatus of claim 11, wherein the repeat execution determining unit compares the collected traffic with the regenerated traffic for testing to determine whether they are similar to each other in order to determine whether the modeling is repeatedly executed and determine whether the repeat execution of the modeling is made according to the result.

15. The apparatus of claim 11, wherein the repeat execution determining unit performs the repeat execution when the difference between the largest density value of the major dataset and the smallest density value is a predetermined threshold value different from the threshold value.

16. The apparatus of claim 11, wherein the repeat execution determining unit is based on the repeat execution but may be configured so that the repeat execution ends when the total sum of the data density of the remaining dataset after the separation is the predetermined value or less.

17. The apparatus of claim 13, wherein the regenerator receives two or more mathematical analysis model according to the repeat execution of the modeling from the traffic modeling module or the repeat execution determining unit and the conversion table corresponding to each analysis model when the repeat execution is made to generate two or more regenerated data according to each analysis model and integrate them, thereby generating the regenerated traffic for test.

18. The apparatus of claim 10, wherein the traffic modeling module includes:
a separator that separates the data into the major dataset that is a group of data having the density value of the threshold value and the minor dataset that is a group of data having the data density value less than the threshold value;
a domain transformer that transforms the major dataset on the raw domain into a dataset on the major dataset domain formed to exclude the minor dataset; and
a graph fitting unit that obtains the mathematical analysis model represented by a sum of a plurality of random distribution functions by applying a graph fitting algorithm on the transformed major dataset.

19. The apparatus of claim 18, wherein the separator includes a moving average calculator that calculates a moving average value for the data density value, and separates the major dataset from the minor dataset by using the moving average value as the threshold value.

20. The apparatus of claim 18, wherein the traffic modeling module includes a transformation table generator generating a transformation table indicating the relation that the major dataset on the raw domain is transformed into the major dataset on the major dataset domain.
